(19) United States
(12) Patent Application Publication
(10) Pub. No.: US 2023/0194560 A1
(43) Pub. Date: Jun. 22, 2023

(54) INDUSTRIAL TRUCK WITH MOTOR SPEED DETECTION AND ASYNCHRONOUS MOTOR

(71) Applicant: HUBTEX MASCHINENBAU GMBH & CO. KG, FULDA (DE)

(72) Inventor: JUERGEN KELLER, GROSSENLUEDER (DE)

(73) Assignee: HUBTEX MASCHINENBAU GMBH & CO. KG, FULDA (DE)

(21) Appl. No.: 17/916,802

(22) PCT Filed: Mar. 23, 2021
(86) PCT No.: PCT/EP2021/057410

§ 371 Date: Oct. 4, 2022

(30) Foreign Application Priority Data
Apr. 6, 2020 (DE) 10 2020 109 534.1

(51) Int. Cl. G01P 3/44; G01P 1/02

(52) U.S. Cl. CPC G01P 3/44; G01P 1/026; B66F 9/07572

(57) ABSTRACT

An industrial truck includes a drive unit having a three-phase motor, a motor shaft which extends from the three-phase motor, and a rotational speed detection device for detecting a rotational speed of the motor shaft for controlling the three-phase motor. The rotational speed detection device includes at least one magnetic transmitter element which is arranged on the motor shaft, and at least three magnetic field sensors which are arranged radially around the motor shaft in a transverse plane for detecting the rotational speed of the motor shaft.

### CROSS REFERENCE TO PRIOR APPLICATIONS

This application is a U.S. National Phase application under 35 U.S.C. § 371 of International Application No. PCT/EP2021/057410, filed on Mar. 23, 2021 and which claims benefit to German Patent Application No. 10 2020 109 534.1, filed on Apr. 6, 2020. The International Application was published in German on Oct. 14, 2021 as WO 2021/204528 A1 under PCT Article 21(2).

### FIELD

The present invention relates to an industrial truck comprising a drive unit having a three-phase motor and a motor shaft extending from the three-phase motor, and comprising a rotational speed detection device for detecting the rotational speed of the motor shaft for controlling the three-phase motor. The present invention further relates to a three-phase asynchronous motor for such an industrial truck.

Industrial trucks are used for the storage, retrieval and transport of goods and are well known in numerous variants. The present invention is not limited to a particular type of industrial truck. Examples an industrial truck include an embodiment such as a pallet truck or a lift mast truck.

Three-phase motors are likewise well known. It should be clear that a three-phase motor is to be understood as an alternating current three-phase motor. The three-phase motor in the present case can, for example, be designed as a three-phase asynchronous electric motor that is installed in a drive axle of an industrial truck for driving the drive wheels. Such a motor can be designed as a brushless, electronically commutated motor, for example, as an asynchronous motor having a frequency converter. The three-phase motor generally has a motor housing made of a ferromagnetic material, in particular steel, and serves to support the motor shaft. The motor housing can in particular also form the axle housing, wherein the motor stator is fixed in the housing and the motor rotor passes through the electric motor and is driven by the electric motor.

The motor shaft is in particular to be understood as the drive shaft of the three-phase motor, which drive shaft serves as a motor rotor.

Rotational speed detection devices for controlling the three-phase motor are also known. Optically or magnetically operating systems are in particular known. Based on the desired vehicle speed, vehicle acceleration and/or direction of travel, the actual rotational state of the motor shaft is hereby generally detected by a rotational speed sensor, such as a rotary encoder, and an output signal is, for example, returned to a drive inverter of the motor. In known drive units, such a rotational speed return is usually implemented on a bearing, in particular with what is referred to as a rotational speed sensor bearing. In order to detect the rotational speed, a motor bearing is in this case designed and used as a rotational speed sensor bearing, wherein an incremental signal detected on the rotational speed sensor bearing is output to a rotational speed control device.

It has been shown, however, that the output signals of such rotational speed sensor bearings were often disturbed, so that a reliable actual value detection of the rotational state of the motor shaft could not be ensured. In particular in the case of integrated drive motors, however, the reliable detection of the rotational state of a drive shaft is important for ensuring that a reliable drive control can be realized. A reliable and safe control and regulation of the drive unit is furthermore required for autonomous driving vehicles, which are currently increasingly in demand.

Such rotational speed sensor bearings are in particular elaborate and complex in their construction, in particular with regard to their structure and their arrangement. Rotational speed sensor bearings which are arranged in a separate housing part in particular require a relatively large amount of effort in terms of production and maintenance or repair. Due to their installation situation, such rotational speed sensor bearings are in particular relatively difficult to access from the outside and can usually be repaired or replaced only with a relatively high effort. Industrial trucks having such sensor bearings are therefore relatively cost-intensive in terms of production and operation.

### SUMMARY

An aspect of the present invention is to provide an industrial truck which improves upon at least one of the above-mentioned disadvantages and which in particular allows for a safe and maintenance-friendly drive unit.

In an embodiment, the present invention provides an industrial truck which includes a drive unit comprising a three-phase motor, a motor shaft which extends from the three-phase motor, and a rotational speed detection device for detecting a rotational speed of the motor shaft for controlling the three-phase motor. The rotational speed detection device comprises at least one magnetic transmitter element which is arranged on the motor shaft, and at least three magnetic field sensors which are arranged radially around the motor shaft in a transverse plane for detecting the rotational speed of the motor shaft.

### BRIEF DESCRIPTION OF THE DRAWINGS

The present invention is described in greater detail below on the basis of embodiments and of the drawings in which:

FIG. 1 shows a detail of a drive unit according to the present invention of an industrial truck in a longitudinal sectional view; and

FIG. 2 shows a detail of a three-phase motor according to the present invention in a cross-sectional view.

### DETAILED DESCRIPTION

According to the present invention, the rotational speed detection device has at least one magnetic transmitter element, in particular at least one permanent magnet, arranged on the motor shaft, and at least three magnetic field sensors arranged radially around the motor shaft, in particular on the peripheral side of the motor shaft, in a transverse plane for detecting the rotational speed of the motor shaft. The rotational speed detection is thereby particularly safe and reliable. Two of the three sensors can in particular function as replacement sensors by virtue of the fact that they are only activated or the rotational speed of the motor shaft is only detected when the at least one other sensor has a malfunction or fails. A first magnetic field sensor can in particular be operated as an active sensor that outputs the data for controlling the three-phase motor, while the other two magnetic field sensors are not used for regulation, but instead serve as redundant devices. The two non-active rotational speed sensors in this case in particular provide a passive redundancy and are in particular only active when the first magnetic field sensor has a malfunction or has failed. The two other sensors or the detection signals thereof can alternatively or additionally be used for comparison purposes in order to be able to detect a possible malfunction of the system particularly quickly.

In order to determine the rotor position of the motor shaft, in particular of the motor rotor, a combination of or an operative connection between at least one magnet designed as the transmitter element and the at least three magnetic field sensors is used in the present case, wherein the at least one magnet is connected to the rotor and generates a measuring magnetic field in which the magnetic field sensors are each arranged. The magnetic field sensor is stationary and the magnet is connected to the rotor in a rotationally fixed manner so that the magnet, together with its measuring magnetic field, rotates relative to the magnetic field sensors. The magnet can in particular be designed as a permanent magnet, for example, as a ring magnet. The angle of the measuring magnetic field can be determined by the magnetic field sensors so that the position of the rotor can be deduced. This provides for a particularly safe detection of the rotational speed and for a rapid interchangeability of the detection device. The at least three magnetic field sensors arranged on the outside around the motor shaft are in particular accessible from the outside in a particularly simple manner. Such a rotational speed sensor is furthermore permanently safe and reliable in its function, so that reliable operation of the drive unit of the industrial truck is made possible. The rotational speed sensors can be designed, for example, as a magnet-based sensor that outputs an incremental A/B track having a defined number of pulses per motor revolution.

The magnetic field sensors can, for example, be distributed evenly in the circumferential direction of the motor shaft. The magnetic field sensors can be arranged, for example, at the same circumferential distance from one another, for example, in the case of three magnetic field sensors, at an angle about the motor shaft of 120 degrees in each case. The at least three magnetic field sensors can, for example, be arranged at an angle about the motor shaft of 60 degrees relative to one another. This provides a particularly safe detection of the rotational speed of the motor shaft. The sensors can thereby in particular be quickly accessible from the outside and can thus be replaced in a particularly simple manner in the event of a malfunction.

The at least three magnetic field sensors can, for example, be arranged coaxially with respect to the motor shaft. The magnetic field sensors can in each case in particular be arranged at the same circumferential distance from one another. A particularly advantageous accessibility of each individual magnetic field sensor from the outside is thereby possible.

The at least three magnetic field sensors can, for example, be arranged in a region of a bearing-free portion of the motor shaft. This in particular means that the motor shaft has no bearing or no support in the region of the magnetic field sensors. The three magnetic field sensors are in particular not arranged radially adjacent to a bearing of the motor shaft. Interference on the magnetic field sensors induced by the bearing can thereby be avoided.

The magnetic field sensors can, for example, in each case be designed as a Hall sensor. Hall sensors in particular offer the advantage that they are very insensitive to dirt and water because they contain non-ferromagnetic components.

The at least three magnetic field sensors can, for example, in each case be inserted or integrated into a receptacle, in particular a bearing shield of the motor housing. The rotational speed detection device is particularly compact and space-saving as a result.

The rotational speed detection device can, for example, have a gearwheel that is connected to the motor shaft, for example, in a rotationally fixed manner in the transverse plane, wherein the magnetic field sensors are arranged radially with respect to the gearwheel. The gearwheel can in particular have at least one transmitter element or be designed as such itself. The gearwheel can, for example, be designed so that a magnetic field generated thereby or thereon can be generated, which magnetic field follows the rotation of the motor shaft. The magnetic field can fluctuate in the circumferential direction around the motor shaft. This can be achieved, for example, by the gearwheel having a plurality of permanent magnets that are distributed around the gearwheel in a distributed manner in the circumferential direction. The active magnetic field sensor which is designed, for example, as a Hall sensor can, for example, scan the gearwheel connected to the motor shaft and can thereby output an incremental A/B track having a defined number of pulses per motor revolution. In such an arrangement, the magnetic field sensors are further interchangeable from the outside and are particularly resistant to malfunctions, thereby providing a reliable operation of the motor.

The at least one magnetic transmitter element can, for example, be arranged on the gearwheel or a toothed segment of the gearwheel. The gearwheel or a toothed segment of the gearwheel as a transmitter element can, for example, have a magnet ring that is operatively connected to the at least one active magnetic field sensor. In an embodiment, the gearwheel can, for example, have a total of eighty toothed segments. This allows for a particularly safe operation of the rotational speed detection device.

The at least one magnetic transmitter element, for example, the magnet ring, can, for example, be embedded in the gearwheel or in the toothed segment. This allows for a particularly safe operation and a particularly compact configuration of the rotational speed detection device.

The three-phase motor can, for example, form a driving motor of the industrial truck. The three-phase motor can, for example, be installed in a drive axle of an industrial truck for driving the drive wheels. This makes a particularly safe, reliable and compact system possible.

An embodiment of the present invention is explained in greater detail below under reference to the drawings.

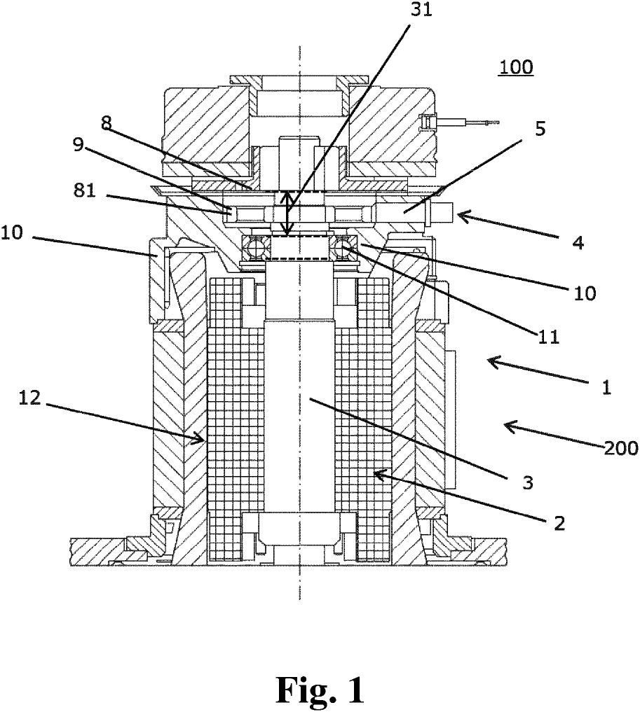

FIG. 1 shows a longitudinal sectional view of a drive unit 1 of an industrial truck 100 (which is not shown in more detail). The drive unit 1 in particular comprises a three-phase motor 2 and a motor shaft 3.

In the present case, the three-phase motor 2 is designed as a three-phase asynchronous motor 200, which is used as a travel drive of the industrial truck 100. The three-phase motor 2 in particular has a motor housing 10 and a motor part 12 arranged therein. The motor shaft 3 extends through the motor part 12 and is supported, for example, by a bearing 11 relative to the motor housing 10.

A rotational speed detection device 4 is provided in a region of the drive unit 1 arranged outside the motor part 12. The rotational speed detection device 4 serves to control the rotational speed of the three-phase motor 2. For this purpose, the rotational speed of the motor shaft 3 is detected by the rotational speed detection device 4 and a corresponding signal is transmitted or returned to a drive inverter (not shown) for actuating the motor part 12. The signals, which are evaluated by a controller, are necessary, for example, to switch protection fields of personal protection scanners installed on the industrial truck 100.

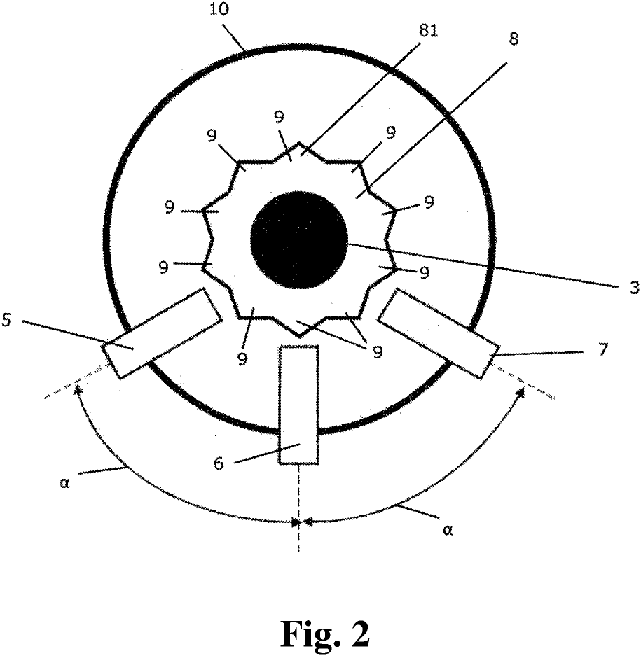

The rotational speed detection device 4 is in particular arranged in a portion 31 of the motor shaft 3 in which the motor shaft 3 has no bearing. In the present case, a bearing 11 is provided axially adjacent to portion 31, but not in portion 31. In order to detect the rotational speed of the motor shaft 3, the rotational speed detection device 4 in the present case comprises three magnetic field sensors 5, 6, 7 which are arranged radially spaced apart from the motor shaft 3. As can in particular be seen in FIG. 2, the magnetic field sensors 5, 6, 7 are arranged coaxially with respect to the motor shaft 3 and in the circumferential direction of the motor shaft 3 at an angle to one another of approximately 60 degrees. Due to the arrangement of all three sensors 5, 6, 7 on one half of the motor shaft 3, these are interchangeable, for example, in a particularly simple manner.

The three magnetic field sensors 5, 6, 7 are in the present case in each case designed as a Hall sensor and are arranged in a receptacle or a bearing shield of the motor housing 10. In this case, two of the three Hall sensors 5, 6, 7 are always provided for an emergency, in particular if one of the Hall sensors 5, 6, 7 should fail. This means that the system is of a dual redundancy design. In particular, a first Hall sensor 5 can be used actively for the rotational speed return to the drive inverter, while the two other Hall sensors 6, 7 are used for redundant rotational speed detection and/or only in the event of a failure or a malfunction of the first Hall sensor 5.

By using three Hall sensors 5, 6, 7 per three-phase motor 2, a redundancy is provided which is necessary for a particularly safe control system of the three-phase motor 2 and in particular for an autonomous or computer-controlled industrial truck 100. Such a safe system is in particular required in order to be able to use the three-phase motor 2 in a driverless or autonomous industrial truck 100. The safety-related requirements for autonomous driving, in particular DIN EN ISO 13849, can thus be met.

In the shown embodiment, the rotational speed detection device 4 additionally has a gearwheel 8 connected to the motor shaft 3, wherein the Hall sensors 5, 6, 7 are arranged radially with respect to the gearwheel 8. The gearwheel 8 has a plurality of toothed segments 81, each having magnets 9 that can be brought into operative connection with the Hall sensors 5, 6, 7. In one particular embodiment, a magnet ring 9 can also be provided. This magnet ring 9 can in particular be embedded in the gearwheel 8 or in the toothed segment 81.

It should be clear that the scope of protection of the present invention is not limited to the described embodiments. The structure of the three-phase motor can in particular be modified without changing the essence of the present invention. Reference should also be had to the appended claims.

LIST OF REFERENCE SIGNS

| | |
|---|---|
| 1 | Drive unit |
| 2 | Three-phase motor |
| 3 | Motor shaft |
| 31 | Portion |
| 4 | Rotational speed detection device |
| 5 | Magnetic field sensor / First Hall sensor |
| 6 | Magnetic field sensor / Other Hall sensor |
| 7 | Magnetic field sensor / Other Hall sensor |
| 8 | Gearwheel |
| 81 | Toothed segment |
| 9 | Magnet / Magnetic ring |
| 10 | Motor housing |
| 11 | Bearing |
| 12 | Motor part |
| 100 | Industrial truck |
| 200 | Three-phase asynchronous motor |
| α | Angle |

1-11. (canceled)

12. An industrial truck comprising:
a drive unit comprising a three-phase motor;
a motor shaft which extends from the three-phase motor; and
a rotational speed detection device for detecting a rotational speed of the motor shaft for controlling the three-phase motor, the rotational speed detection device comprising,
at least one magnetic transmitter element which is arranged on the motor shaft, and
at least three magnetic field sensors which are arranged radially around the motor shaft in a transverse plane for detecting the rotational speed of the motor shaft.

13. The industrial truck as recited in claim 12, wherein the at least three magnetic field sensors are arranged at an angle about the motor shaft of 60 degrees with respect to one another.

14. The industrial truck as recited in claim 12, wherein the at least three magnetic field sensors are arranged coaxially with respect to the motor shaft.

15. The industrial truck as recited in claim 12, wherein the at least three magnetic field sensors are arranged in a portion of the motor shaft which is bearing-free.

16. The industrial truck as recited in claim 12, wherein each of the at least three magnetic field sensors is designed as a Hall sensor.

17. The industrial truck as recited in claim 12, wherein each of the at least three magnetic field sensors is inserted into or integrated into a receptacle.

18. The industrial truck as recited in claim 17, wherein the receptacle is a bearing shield of the motor housing.

19. The industrial truck as recited in claim 12, wherein,
the rotational speed detection device further comprises a gearwheel which is connected to the motor shaft, and
the at least three magnetic field sensors are arranged radially with respect to the gearwheel.

20. The industrial truck as recited in claim 19, wherein
the gearwheel comprises a toothed segment, and
the at least one magnetic transmitter element is arranged on the gearwheel or on the toothed segment of the gearwheel.

21. The industrial truck as recited in claim 20, wherein the at least one magnetic transmitter element is embedded in the gearwheel or in the toothed segment of the gearwheel.

22. The industrial truck as recited in claim 12, wherein the three-phase motor forms a driving motor of the industrial truck.

23. A three-phase asynchronous motor for the industrial truck as recited in claim 12.
